(19) United States
(12) Patent Application Publication
(10) Pub. No.: US 2026/0220086 A1
(43) Pub. Date: Jul. 30, 2026

(54) METHOD AND APPARATUS FOR FLEXIBLE PARTITIONING OF DATA IN LSM-LIKE TABLES

(71) Applicant: HUAWEI TECHNOLOGIES CO., LTD., Shenzhen (CN)

(72) Inventor: Robin GROSMAN, Markham (CA)

(73) Assignee: HUAWEI TECHNOLOGIES CO., LTD., Shenzhen (CN)

(21) Appl. No.: 19/040,331

(22) Filed: Jan. 29, 2025

(51) Int. Cl. H04L 9/32

(52) U.S. Cl. CPC H04L 9/3236

(57) ABSTRACT

There is provided a method and device for partitioning a database such that any partition is both hash-partitioned and range-partitioned. An entry may be stored on a partition which corresponds to the output of a hash function on the primary key of the entry, and which is associated to a range to which the primary key belongs. This may be implemented in LSM tables or similar systems. A global compaction process may be used to reorganize the data periodically.

### CROSS-REFERENCE TO RELATED APPLICATIONS

The present application is the first application for this disclosure.

### FIELD OF THE DISCLOSURE

The present disclosure relates to database management. Specifically, the present disclosure provides flexible partitioning of data in Log-Structured Merge (LSM) trees or similar tables.

### BACKGROUND

In LSM tables, data is stored in runs at different levels. As the level increases, so does the size of runs and the size of the level. Because each level is bigger than the previous level, a search of all levels can be performed in O(log N) time.

For analytics, a secondary mutable structure of delete bitmaps is maintained, allowing queries from different levels to be combined without merging data based on a primary key.

Compaction is a process performed by LSM tables to create longer sorted runs, allowing for a more efficient search of these runs.

### SUMMARY

It is an object of the present disclosure to provide an improved method for flexible partitioning of data in LSM-like tables.

According to a first aspect, there is provided a method in a database system comprising a plurality of nodes, each of the plurality of nodes comprising different levels, the method comprising specifying, for each level on each of the plurality of nodes, a hash value and a range, receiving a new entry, the entry comprising a primary key; computing a hash function on the primary key; selecting a level on a node for which the hash value matches the computed hash function for the primary key and for which the range comprises the primary key; and routing the new entry to the selected level.

According to an embodiment of the first aspect, the method further comprises receiving a query, the query comprising a query range; selecting all levels for which the range intersects the query range; and performing a search on the selected level.

According to another embodiment of the first aspect, the method further comprises receiving a query, the query comprising a query key; computing the hash function on the query key; selecting a target level on a target node for which the hash value matches the computed hash function for the query key and for which the range comprises the query key; and performing a search on the target level.

According to yet another embodiment of the first aspect, the method further comprises prior to said routing, performing a uniqueness check for the new entry on all levels which match the computed hash function and for which the range comprises the primary key.

According to yet another embodiment of the first aspect, the method further comprises periodically performing a compaction process on each of the levels of each node.

According to yet another embodiment of the first aspect, the compaction process is global for each of the plurality of nodes.

According to yet another embodiment of the first aspect, the compaction process produces a plurality of runs.

According to yet another embodiment of the first aspect, the compaction process produces one run for each node.

According to yet another embodiment of the first aspect, each node of the plurality of nodes comprises a first level, and wherein said specifying assigns a hash value to the first level of each node and wherein said specifying assigns all hash values to other levels of each node.

According to yet another embodiment of the first aspect, said specifying assigns a range with no upper bound to the first level of each node and said specifying assigns a node-specific range to the other levels of each node.

According to a second aspect, there is provided a computing device for managing a database system comprising a plurality of nodes, each of the plurality of nodes comprising different levels, the computing device comprising a processor and a communications subsystem, the computing device being configured to specify, for each level on each of the plurality of nodes, a hash value and a range, receive a new entry, the entry comprising a primary key; compute a hash function on the primary key; select a level on a node for which the hash value matches the computed hash function for the primary key and for which the range comprises the primary key; and route the new entry to the selected level.

According to an embodiment of the second aspect, the computing device is further configured to receive a query, the query comprising a query range; select all levels for which the range intersects the query range; and perform a search on the selected level.

According to another embodiment of the second aspect, the computing device is further configured to receive a query, the query comprising a query key; compute the hash function on the query key; select a target level on a target node for which the hash value matches the computed hash function for the query key and for which the range comprises the query key; and perform a search on the target level.

According to yet another embodiment of the second aspect, the computing device is further configured to prior to said routing, perform a uniqueness check for the new entry on all levels which match the computed hash function and for which the range comprises the primary key.

According to yet another embodiment of the second aspect, the computing device is further configured to periodically perform a compaction process on each of the levels of each node.

According to yet another embodiment of the second aspect, the compaction process is global for each of the plurality of nodes.

According to yet another embodiment of the second aspect, the compaction process produces a plurality of runs.

According to yet another embodiment of the second aspect, the compaction process produces one run for each node.

According to yet another embodiment of the second aspect, each node of the plurality of nodes comprises a first level, and wherein said specifying assigns a hash value to the first level of each node and wherein said specifying assigns all hash values to other levels of each node.

According to yet another embodiment of the second aspect, said specifying assigns a range with no upper bound to the first level of each node and said specifying assigns a node-specific range to the other levels of each node.

According to a third aspect, there is provided a computer readable medium having stored thereon executable code for execution by a processor of a computing device, the executable code comprising instructions for specifying, for each level on each of the plurality of nodes, a hash value and a range, receiving a new entry, the entry comprising a primary key; computing a hash function on the primary key; selecting a level on a node for which the hash value matches the computed hash function for the primary key and for which the range comprises the primary key; and routing the new entry to the selected level.

### BRIEF DESCRIPTION OF THE DRAWINGS

FIG. 1 is an illustration of an LSM tree structure according to at least some embodiments of the present disclosure.

FIG. 2 is an illustration of a database using LSM tree structures according to at least some embodiments of the present disclosure.

FIG. 3 is a flow diagram of a method for inserting a new row in a database according to at least some embodiments of the present disclosure.

FIG. 4 is a flow diagram of a method for processing a query according to at least some embodiments of the present disclosure.

FIG. 5 is a flow diagram of a method for processing a query according to at least some embodiments of the present disclosure.

FIG. 6 is a block diagram of a computing device according to at least some embodiments of the present disclosure.

### DETAILED DESCRIPTION

The present disclosure provides an improved method for flexible partitioning of data in LSM-like tables.

Throughout the present disclosure, the following terminology will be followed.

LSM tree: a data structure that maintains key-value pairs and stores the data in a sorted order. Data is stored in levels and once a level is full, it is flushed to a lower level which typically has a bigger size.

Level: A set of runs within an LSM tree. An LSM tree comprises multiple levels, with the lowest level being the smallest, and the highest level being the largest.

Run: Each level in LSM tree consists of multiple data blocks called runs. Typically, runs are sorted on a desired column.

In large systems, partitioning of data across multiple nodes is important for scalability. There are two main approaches for partitioning data: hash partitioning, and range partitioning.

Hash partitioning works by selecting a column of a table that serves as the hash key, and computing the value of a hash function on the hash key value for a particular entry. The result of the hash function is used to select a partition or node on which the entry is stored. This ensures that all entries sharing the same hash key value are stored on the same partition.

Traditional Relational Database Management Systems (RDBMS) use hash partitioning to store entries to specific nodes. It is beneficial when checking whether an entry is unique, as only one node needs to be searched instead of all nodes.

However, when a query involves a small range of values, all nodes still need to be searched as there is no guarantee that an entry within the small range will be on a particular node.

Another issue with hash partitioning is due to tables of small size which are partitioned in a large number of nodes, leading to large overhead.

Range partitioning works by selecting a column of a table and partitioning entries of a given range on the same node. Range partitioning is mostly used in large systems where checking for a unique entry is less common. This approach works well with queries involving small ranges as they generally can be directed to a single node.

However, when newly inserted data falls within a narrow range, all this data is routed to the same node, thereby reducing throughput when compared to routing new data to different nodes.

Furthermore, if ranges need to be defined at initialization, this approach may be sensitive to the selected ranges, making it a more complex approach for a user to use.

In share-everything databases, any node can access all the data, and nodes need to be notified of recently added data that is not yet stored on disk. In some cases, the same data may be cached by multiple nodes for read queries. Moreover, as any node can insert data, updates and locks need to be coordinated to ensure the uniqueness constraint holds.

Currently, users need to choose between range or hash partitioning for a given table. As discussed above, each approach has advantages and disadvantages for different access patterns. As data ages, the access patterns change and the optimal partitioning approach for that data may change also. Moreover, the number of partitions is fixed for the life of a table.

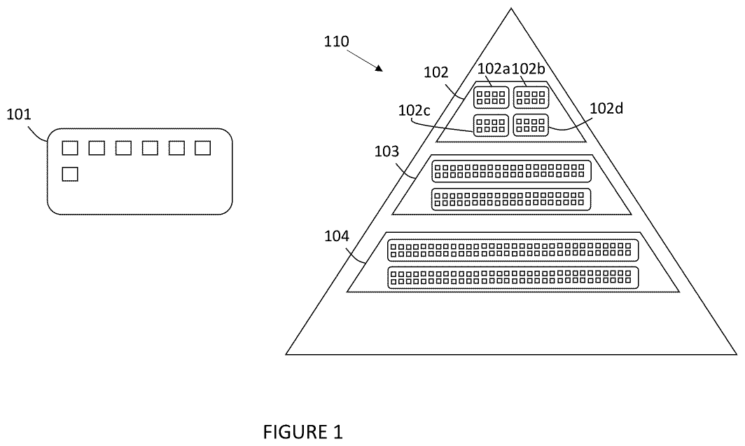

Reference is now made to FIG. 1 which shows a typical LSM tree storage.

As seen in FIG. 1, an LSM tree 110 comprises a plurality of levels, 102, 103, and 104, and a memory table 101. As will be appreciated, while three levels are shown, this is for exemplary purposes only and is not intended to be limiting.

When new data is received for storage in the LSM tree 110, it is initially stored in memory table 101. Memory table 101 is maintained in memory, as opposed to a disk, and is easily and rapidly accessible. Data in memory table 101 may be sorted based on a first key value, as it comes in. When memory table 101 is full, it is flushed to the disk, namely, to the first level 102.

Data stored in the levels of LSM tree 110, such as level 102, may be stored in runs, such as runs 102a, 102b, 102c, and 102d. Runs may be sorted, and combined with other runs, in a process called “compaction”. The compaction process may run in the background to periodically rearrange the data stored in the LSM tree. During compaction, data from a higher level may be pushed down to a lower level.

In an example scenario, a user inserts data to an LSM tree, while ensuring that the data entered is unique. Assuming 4 nodes which are hash-partitioned, with each node being range-partitioned with the following ranges: 0 to 3 million, 3 million to 6 million, 6 million to 9 million, and 9 million to infinity. Furthermore, in this example we assume an ingest rate of 100,000 rows per second, and small queries (e.g., between 10-100 rows) running at the same time.

In this scenario, each node is capable of receiving 100,000 rows of new data per second, and as the 4 nodes are hash-partitioned, the new data is evenly distributed between the 4 nodes, providing a total ingest rate of 400,000 rows per second. However, for running queries, for example a query for values between 5,000,001 and 5,000,100, each of the 4 nodes are searched, as they each potentially contain rows with values in that range. In an example with more nodes than 4, this problem would be even worse, as each node would need to be searched.

In another example scenario, assuming 4 nodes which are range-partitioned, such that node 1 contains values between 0 and 3 million, node 2 contains values between 3 million and 6 million, node 3 contains values between 6 million and 9 million, and node 4 contains values higher than 9 million. In this example, when new data is ordered, such that all new rows are within the same range, all the new data is routed to the same node, providing only an ingest rate of 100,000 rows per second (or only the ingest rate of a single node). In this case, the ingest rate is ¼ the rate of the previous scenario, but generally, with N nodes, the ingest rate would be 1/N the ingest rate of the hash-partitioning approach. However, the queries are handled efficiently, because only one node needs to be searched for each query.

According to at least some embodiments of the present disclosure, partitioning can be specified per level as a combination of range-partitioning and hash-partitioning. This allows partitioning to change as data ages, allowing older data to accommodate small range queries, and new data to benefit from the high ingest rate provided by hash-partitioning. Partitions may be updated by compaction as described in greater detail below.

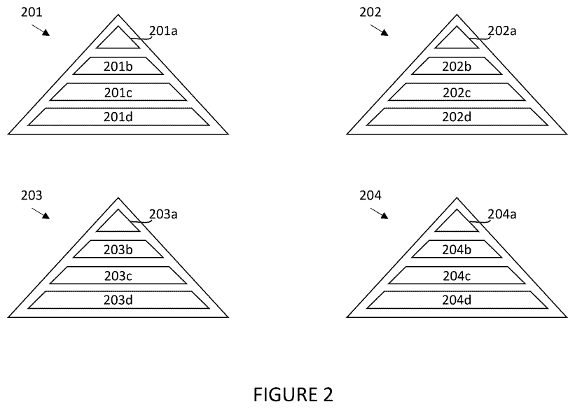

Reference is made to FIG. 2, which shows an exemplary database according to at least some embodiments of the present disclosure. As seen in FIG. 2, the database comprises 4 nodes, namely nodes 201, 202, 203, and 204. Each node has 4 levels, such that node 201 comprises a first level 201a, a second level 201b, third level 201c, and fourth level 201d. Similarly, node 202 comprises a first level 202a, a second level 202b, third level 202c, and fourth level 202d, node 203 comprises a first level 203a, a second level 203b, third level 203c, and fourth level 203d, and node 204 a first level 204a, a second level 204b, third level 204c, and fourth level 204d.

In the scenario of FIG. 2, it is assumed that newly received data will have a primary key value above 9 million. This is only for illustrative purposes and the present disclosure is not limited in this respect.

Each of the levels of each node are hash-partitioned and range partitioned. For example, the hash function may be a modulo-4 function on the primary key, such that the hash function produces an output of 0, 1, 2, or 3. Level 201a may store entries that produce a hash of 0, within the range of 9 million or more, and levels 201b, 201c, and 201d may store entries for all hash outputs, within a range between 0 and 3 million. Similarly, level 202a may store entries that produce a hash of 1, with a primary key of 9 million or more, and levels 202b, 202c, and 202d may store entries for all hash outputs, within a range between 3 and 6 million, level 203a may store entries that produce a hash of 2, within the range of 9 million or more, and levels 203b, 203c, and 203d may store entries for all hash outputs, within a range between 6 and 9 million, level 204a may store entries that produce a hash of 3, within the range of 9 million or more, and levels 203b, 203c, and 203d may store entries for all hash outputs, within the range of between 9 million or more.

Based on the above, as new data is received (having a primary key value of above 9 million), it will be routed to either level 201a of node 201, level 202a of node 202, level 203a of node 203, or level 204a of node 204, depending on the hash function output. Notably, levels 204b, 204c, and 204d also have a range of 9 million or more, however lower levels are typically reserved for older data, and these levels would therefore store older data that nevertheless has a primary key above 9 million.

Assuming a new row is received with a primary key of 9,000,004, the modulo-4 is 0, and node 1 is selected. The new row is therefore routed to node 1, which stores the new row in first level 201a, as the new row's primary key is within the range of level 201a.

As with the prior art hash-partitioning example discussed above, inserting the new row is efficient and uniqueness can be verified efficiently, as any other entry with a primary key of 9,000,004 would be stored in either level 201a, 204b, 204c, or 204d, and therefore only these levels need to be searched for an entry with this primary key. Importantly, in a scenario which includes a very large number of nodes, the number of levels to be searched for checking uniqueness of the new row does not increase.

Moreover, and unlike the harsh-partitioning example discussed above, performing queries over a narrow range is much more efficient. For example, running a query for entries within the range of 5,000,001 and 5,000,100 only needs to search level 203b, 203c, and 203d which are all on node 203. Once again, the number of nodes in this example could be greatly increased without affecting the number of levels to be searched to run this query.

Therefore, this approach provides efficiency in both adding new data and running small queries.

Notably, the parameters of this example, such as the number of nodes, the number of levels in each node, and the specific ranges assigned to each level may be modified based on the circumstances.

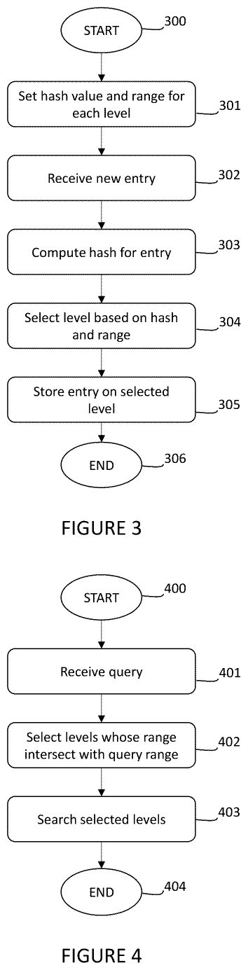

Reference is now made to FIG. 3 which illustrates a method for inserting an entry into a table according to at least some embodiments of the present disclosure. The table may be stored as an LSM-style table, with a plurality of nodes, where each node comprises a plurality of levels.

The method starts at block 300 and proceeds to block 301 where hash values and ranges are specified for each level on a plurality of nodes. The hash values are selected to correspond to each possible output of a hash function. For example, the hash function may be modulo-N, where N is the number of hash-partitions that may be selected. In at least some embodiments, the number of hash-partitions may correspond to the number of nodes, but the present disclosure is not limited in this respect.

Ranges may be user-specified or automatically generated, for example based on overall data volume, the storage capacity of each node, ingest rate, and the like.

In at least some embodiments, the ranges may be arranged such as in the example of FIG. 2, with a first level of each node having a range configured to receive new data, and the lower levels having a range configured to store older data. Specifically, in systems where new entries have an ever-increasing primary key (e.g., serial number or time stamp), higher values will represent newer data. Therefore, the first level of each node may have a range with no upper bound, ensuring that new data is routed to the first level.

In at least some embodiments, the ranges may further be arranged such that older data (e.g., having a primary key lower than a threshold value) is stored in lower levels. For example, some embodiments may be configured as in FIG. 2, where each node's lower levels are not hash-partitioned (i.e., they can store entries which produce any hash value), and all the lower levels within a node has the same range. This allows small queries to be processed by a single node, thereby increasing efficiency.

The method then proceeds to block 302, where a new entry is received. The entry may be any entry to be inserted in a database, and is generally represented as a row of fields, where one field has a value that serves as a primary key. In one non-limiting embodiment, the entry may represent readings from an Internet-of-Things (IoT) device, and the primary key may be a serial number or a time stamp.

The method then proceeds to block 303, where a hash is computed for the entry, based on the primary key for the entry. The present disclosure is not intended to be limiting in respect of the hash function, and any suitable hash function may be used. In at least some embodiments, the hash function is selected to produce an index of a hash-partition, such that any valid index is produced with equal probability.

The method then proceeds to block 304, where a level is selected based on the hash value produced by the hash function at block 303, and based on the range to which the new entry's primary key belongs. If no levels satisfy this requirement, an error message may be returned. If multiple levels satisfy this requirement, different strategies may be employed to select just one level. For example, a level may be selected randomly.

Alternatively, in a scenario such as in FIG. 2, if the new entry has a primary key of 9,000,004, levels 201a, 204b, 204c, or 204d will be selected. However, as level 201a is hash-partitioned, but levels 204b, 204c, or 204d are not (i.e., they can store entries that produce any hash values), level 201a may be selected on the basis that it is the only hash-partitioned level from among the selected levels.

In some embodiments, a uniqueness check may be performed on all the selected levels prior to storing the new entry.

The method then proceeds to block 305, where the new entry is stored on the selected level, and the method ends at block 306.

When a new entry is added, the minimum and maximum values defining a range for a level may change. When this occurs, the database coordinator may be notified, as this information is used to route queries. For lower levels, this information typically only changes during the compaction process, but for new data in the first level, any data could be received. In some cases, the minimum and maximum values may be changed by large increments, in order to prevent these values from being updated too frequently.

Reference is now made to FIG. 4, which illustrates a method for processing a query according to at least some embodiments of the present disclosure.

The method starts at block 400 and proceeds to block 401 where a query is received. In this embodiment, the query specifies a range on the primary key.

The method then proceeds to block 402 where the range from the query is used to select levels who have a range which intersects with the range specified in the query. These levels may be on different nodes, and have different hash-partitioning, however because the query in this case specifies a range of primary keys, the hash-partitioning is not considered as entries with primary key values within the specified range may belong to any hash-partition. In some embodiments, if each node is assigned a specific range, only one node may be selected.

The method then proceeds to block 403 where the selected levels are searched for entries within the specified range. If results are found in multiple levels, these results are combined and returned as a result of the query.

The method then ends at block 404.

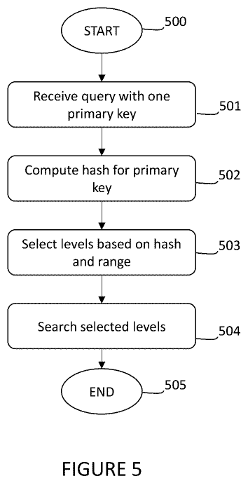

Reference is now made to FIG. 5, which illustrates a method for processing a query with a single primary key according to at least some embodiments of the present disclosure. Queries with a single primary key may be performed, for example, as a uniqueness check before inserting a new entry.

The method starts at block 500 and proceeds to block 501 where a query is received. In this embodiment, the query specifies a single primary key.

The method then proceeds to block 502 where the hash function is computed based on the primary key from the query. The method then proceeds to block 503 where levels which match the hash value and whose range comprise the primary key are selected. These levels may include levels which are not hash-partitioned (i.e., they may store entries which produce any hash value).

The method then proceeds to block 504 where the selected levels are searched for entries comprising the primary key specified in the query, and any hits are returned as a result of the query.

The method then ends at block 505.

In LSM systems compaction is normally done to merge values into bigger and bigger runs. According to at least some embodiments of the present disclosure, the compaction process may be modified in the following ways: 1) compaction is global as opposed to being local to each node, and 2) compaction may produce more than one output run.

Specifically, traditionally compaction is local to each node, meaning that only the data stored on the node is considered, and only data from that node is reorganized together. In contrast, a global compaction process according to some embodiments of the present disclosure means that all the data stored on all nodes may be regrouped and stored on different nodes.

Traditionally, the compaction process output a single run. According to at least some embodiments of the present disclosure, the compaction process may output more than one run. According to at least some embodiments, the compaction process outputs one run per node. Each of the output runs may be assigned a hash partition and/or a range partition.

According to at least some embodiments, when the system is growing, the first, the top level may immediately be moved to all new nodes. Then when compaction runs, the compaction output may be divided across all the new nodes. This allows the system to stay online while moving data to different servers. This may be done without any additional read/write operations over traditional compaction. However, it may take a long time before the highest levels (oldest data) are moved if there is no other compaction process. In some embodiments, compaction may be triggered manually by a user even if some levels are not completely full. Moreover, in this embodiment scan times may be twice as costly, as there may be two runs on the same level with different partitioning schemes, which means accessing twice as many nodes.

The above disclosure may be applied to systems without LSM tables, if there is a data structure which can be partitioned as a combination of range partitioning and hash partitioning. Even without levels, partition meta-data on each partition may indicate which nodes to access and which data on each node to access. Instead of a compaction process, a redistribution process could be used to regroup and reorganize data in new partitions, when required.

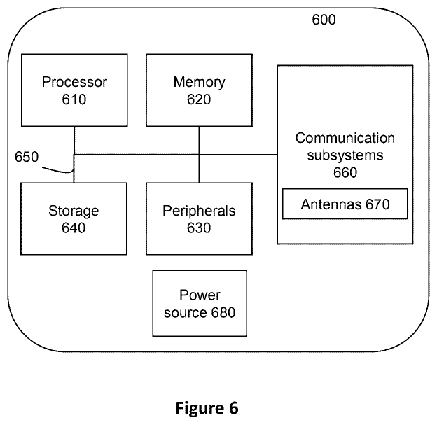

The above functionality may be implemented on any one or combination of computing devices. FIG. 6 is a block diagram of a computing device 600 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 600 may comprise a processor 610, memory 620, a mass storage device 640, and peripherals 630. Peripherals 630 may comprise, amongst others one or more input/output devices, such as a speaker, microphone, mouse, touchscreen, keypad, keyboard, printer, display, network interfaces, and the like. Communications between processor 610, memory 620, mass storage device 640, and peripherals 630 may occur through one or more buses 650.

The bus 650 may be one or more of any type of several bus architectures including a memory bus or memory controller, a peripheral bus, video bus, or the like. The processor 610 may comprise any type of electronic data processor. The memory 620 may comprise any type of system memory such as static random-access memory (SRAM), dynamic random-access memory (DRAM), synchronous DRAM (SDRAM), read-only memory (ROM), a combination thereof, or the like. In an embodiment, the memory 620 may include ROM for use at boot-up, and DRAM for program and data storage for use while executing programs.

The mass storage device 640 may comprise any type of storage device configured to store data, programs (e.g. instructions or code), and other information and to make the data, programs, and other information accessible via the bus. The mass storage device 640 may comprise, for example, one or more of a solid-state drive, hard disk drive, a magnetic disk drive, an optical disk drive, or the like. The memory 620 or mass storage 640 may store instructions, which when executed by a processor or processing unit, cause or configure the computing device 600 to perform any of the methods described herein.

Computing device 600 may further comprise a communications subsystem 660 for communicating with other computing devices or for connecting computing device 600 to a computer network. Communications subsystem 660 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 670 and one or more receivers/receive antennas 670. In an embodiment, the processing unit is coupled to a local-area network or a wide-area network, for data processing and communications with remote devices, such as other processing units, the Internet, remote storage facilities, or the like.

Computing device may further comprise a power source 680.

The present disclosure may be implemented on a computing device such as exemplary computing device 600. Computing device 600 may be a network element of a telecommunications network, such that the network element may be connected to other network elements of the telecommunication network, where all network elements form the telecommunication network. The network element may also receive communications from client devices connected to the telecommunication network and provide services to such client devices.

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method in a database system comprising a plurality of nodes, each of the plurality of nodes comprising different levels, the method comprising:
specifying, for each level on each of the plurality of nodes, a hash value and a range;
receiving a new entry, the entry comprising a primary key;
computing a hash function on the primary key;
selecting a level on a node for which the hash value matches the computed hash function for the primary key and for which the range comprises the primary key; and
routing the new entry to the selected level.

2. The method of claim 1, further comprising:
receiving a query, the query comprising a query range;
selecting all levels for which the range intersects the query range; and
performing a search on the selected levels.

3. The method of claim 1, further comprising:
receiving a query, the query comprising a query key;
computing the hash function on the query key;
selecting a target level on a target node for which the hash value matches the computed hash function for the query key and for which the range comprises the query key; and
performing a search on the target level.

4. The method of claim 1, further comprising, prior to said routing, performing a uniqueness check for the new entry on all levels which match the computed hash function and for which the range comprises the primary key.

5. The method of claim 1, further comprising periodically performing a compaction process on each of the levels of each node.

6. The method of claim 5, wherein the compaction process is global for each of the plurality of nodes.

7. The method of claim 6, wherein the compaction process produces a plurality of runs.

8. The method of claim 7, wherein the compaction process produces one run for each node.

9. The method of claim 1, wherein each node of the plurality of nodes comprises a first level, and wherein said specifying assigns a hash value to the first level of each node and wherein said specifying assigns all hash values to other levels of each node.

10. The method of claim 9, wherein said specifying assigns a range with no upper bound to the first level of each node and said specifying assigns a node-specific range to the other levels of each node.

11. A computing device for managing a database system comprising a plurality of nodes, each of the plurality of nodes comprising different levels, comprising:
a processor;
a communications subsystem;
wherein the computing device is configured to:
specify, for each level on each of the plurality of nodes, a hash value and a range;
receive a new entry, the entry comprising a primary key;
compute a hash function on the primary key;
select a level on a node for which the hash value matches the computed hash function for the primary key and for which the range comprises the primary key;
route the new entry to the selected level.

12. The computing device of claim 11, further configured to:
receive a query, the query comprising a query range;
select all levels for which the range intersects the query range;
perform a search on the selected levels.

13. The computing device of claim 11, further configured to:
receive a query, the query comprising a query key;
compute the hash function on the query key;
select a target level on a target node for which the hash value matches the computed hash function for the query key and for which the range comprises the query key;
perform a search on the target level.

14. The computing device of claim 11, further configured to, prior to said routing, perform a uniqueness check for the new entry on all levels which match the computed hash function and for which the range comprises the primary key.

15. The computing device of claim 11, further configured to periodically performing a compaction process on each of the levels of each node.

16. The computing device of claim 15, wherein the compaction process is global for each of the plurality of nodes.

17. The computing device of claim 16, wherein the compaction process produces a plurality of runs, and one run for each node.

18. The computing device of claim 11, wherein each node of the plurality of nodes comprises a first level, and wherein said specifying assigns a hash value to the first level of each node and wherein said specifying assigns all hash values to other levels of each node.

19. The computing device of claim 18, wherein said specifying assigns a range with no upper bound to the first level of each node and said specifying assigns a node-specific range to the other levels of each node.

20. A computer readable medium having stored thereon executable code for execution by a processor of a computing device, the executable code comprising instructions for:
specifying, for each level on each of the plurality of nodes, a hash value and a range;
receiving a new entry, the entry comprising a primary key;
computing a hash function on the primary key;
selecting a level on a node for which the hash value matches the computed hash function for the primary key and for which the range comprises the primary key;
routing the new entry to the selected level.
